(19) United States
(12) Patent Application Publication
(10) Pub. No.: US 2003/0015879 A1
(43) Pub. Date: Jan. 23, 2003

(54) Anti-burst sliding door latch with lockout protection

(76) Inventors: Burl M. Finkelstein, Newnan, GA (US); Stevie C. Roop, Reston, VA (US)

Correspondence Address: Robert B Kennedy, Baker Donelson Bearman & Caldwell, Five Concourse Parkway Suite 900, Atlanta, GA, 30328, US

(21) Appl. No.: 09/912,410

(22) Filed: Jul. 23, 2001

(51) Int. Cl. E05C 3/02; E05C 3/12

(52) U.S. Cl. 292/213

(57) ABSTRACT

An improved latch for the sliding door of a truck or the like is disclosed. The latch includes a single rotary latch bar with ratchet steps and a locking arm that engages a strike and captures it as the door is moved into a latched position. The locking arm restrains the rotary latch bar so as to prevent it from releasing the strike. A lockout slide is mounted for manual movement within the latch assembly housing for movement into and out of locking engagement with an internal cam. The latch and strike assemblies are adaptable for remote, keyless entry, performed with all electrical components on the stationary side to provide for reliable and repeated use.

### TECHNICAL FIELD

The present invention relates generally to sliding door latches. More particularly, the present invention relates to an anti-burst sliding door latch for a delivery truck or van or similar vehicles that may be subjected to a variety of forces while also preventing inadvertent lockout of an operator.

### BACKGROUND OF THE INVENTION

Package delivery trucks, which have also been known or referred to as panel trucks or vans, are typically provided with a sliding door that provides access to the vehicle for retrieving packages to be delivered. The driver or operator may access the storage compartment of the panel truck without leaving the truck by means of an opening between the driver's position and the storage compartment. The driver, once in the storage compartment of the truck, identifies the package to be delivered and then approaches the panel truck's sliding door. The operator grabs the door handle on the inside of the truck and by manipulation thereof, unlatches the door. The door may then be manually opened by pulling the door toward the rear of the truck along a track. Such doors conventionally provide a latch coupled with the two handles which holds the door in a fully opened or closed position by engagement with strikes mounted adjacent each end of the door. Of course, a variety of vehicles are provided with such doors and latches, including delivery trucks, vans, and other vehicles that includes a sliding door for ready ingress and egress to and from the vehicle. Thus, it is to be understood that the panel truck is used here by way of example and not by way of limitation.

Such sliding doors provide a handle on the outside of the door so that the panel truck door may be opened from either the inside or the outside. For security purposes, these doors have been previously fitted with manually operable inside locks which prevent the door from being opened from the outside while the operator or driver is inside the truck. These inside locks conventionally included a lock bar that could be moved into and out of locking engagement with an internal cam that is operated by the outside handle that cams the latch out of latching engagement with a strike.

For many years, a sliding door latch such as that described hereinabove was sold as Model 4000 series manufactured by Kason Industries, Inc. This arrangement was described in some detail in U.S. Pat. No. 5,979,949, entitled “Sliding Door Latch With Lock-out Protection.” The inventions described and claimed therein address the problem of an operator who has locked the latch while working inside the vehicle and forgot to unlock it upon his or her departure from the vehicle. Once outside the vehicle, the worker may and often did slide the door shut so as to be inadvertently locked out of the vehicle. The Kason Industries 4000 series latch has proven its usefulness over the test of time.

Kason also invented the inventions described and claimed in U.S. Pat. No. 5,520,423, entitled “Anti-Burst Latch.” The inventions described and claimed therein address the need for a rugged latch that is less likely to become accidentally unlatched upon the application of forces of diverse magnitudes and direction applied thereto. For example, the jostling of the vehicle over rough roads or the impact of a collision could cause the door to become accidentally unlatch and to open and result in personal injury to the driver or operator, and damage to the contents contained in the truck.

Thus, while the inventions described and claimed in the '949 patent prevented inadvertent lockouts and the inventions described and claimed in the '423 patent prevented accidental unlatching of the latch due to a variety of forces, there has for many years been a need in the art for a latch that is both rugged and prevented inadvertent lock-out of the operator. The present invention is directed to providing both functions.

### SUMMARY OF THE INVENTION

The present invention fills the above-described need in the prior art by providing a rugged anti-burst latch for a sliding door that does not readily open when subjected to a variety of forces and that also prevents inadvertent lockout of an operator or driver.

Briefly described, the present invention comprises a radial rotary action two-sided latch that is able to maintain a sliding vehicle door in either an open or closed position.

Described somewhat more particularly, the present invention comprises an improved latch for a sliding door of a truck or the like, including a single rotary latch bar with ratchet steps and a locking arm whereby the rotary latch bar engages a strike and captures it as the door is moved into a latched position, and the locking arm restrains the rotary latch bar so as to prevent it from releasing the strike. In an alternative form of the invention, a locking slide is provided to engage a notch defined in the rotary latch bar, thereby preventing it from moving and releasing the strike. The locking slide may preferably be activated by either a manual slide inside of the vehicle or by a key cylinder outside of the vehicle. The locking slide action is independent of the locking arm that restrains the rotary latch bar. In yet another form of the invention, the locking slide is detented in a locked or open position by a set of fingers.

Thus, it is an object of the present invention to provide an improved anti-burst latch for a sliding door for a vehicle.

It is a further object of the present invention to provide an improved anti-burst latch for a sliding door that prevents inadvertent lockout of the operator or driver.

It is a further object of the present invention to provide an improved anti-burst latch for a sliding door that is capable of utilizing a single rotor.

It is a further object of the present invention to provide an improved anti-burst latch for a sliding door that can be opened from the outside if locked on the inside.

It is a further object of the present invention to provide an improved anti-burst latch for a sliding door that can be opened from the inside is locked on the outside.

It is a still further object of the present invention to provide an improved anti-burst latch for a sliding door that is mass balanced so a severe force, such as from collision or the like, is not likely to dislodge the latch.

It is a still further object of the present invention to provide an improved anti-burst latch for a sliding door wherein the lock cylinder may be secured in the door rather than the handle.

It is a still further object of the present invention to provide an improved anti-burst latch for a sliding door that may protect working parts from the elements.

It is a still further object of the present invention to provide an improved anti-burst latch for a sliding door that may allow for a wider range of cylinder sizes for certain applications.

It is a still further object of the present invention to provide an improved anti-burst latch for a sliding door that can be adapted to a remote access system mounted solely on the jamb side of the door.

These and other objects, features and advantages of the present invention will become apparent from a reading of the following detailed description of the preferred embodiments in conjunction with the appended drawings.

### BRIEF DESCRIPTION OF THE DRAWINGS

FIG. 1 is a plan view of a preferred embodiment of the present invention in an open position.

FIG. 2 is a plan view of a preferred embodiment of the present invention in a closed position.

FIG. 3 is a plan view of the outside of the preferred embodiment shown in FIG. 2.

FIG. 4 is a plan view of the interior of the rotary latch housing assembly of the preferred embodiment shown in FIG. 2, showing the latch rotor assembly and release arm assembly.

FIG. 4A is a plan view of a preferred rotary latch bar, in isolation.

FIG. 5 is a plan view of the interior of the rotary latch housing assembly showing the latch rotor assembly, the release area assembly and the lockout slide assembly.

FIG. 6 is a sectioned, side view of the embodiment shown in FIG. 5, showing an inside handle of the device as mounted to the drive shaft.

FIG. 6A is a sectioned side view of the embodiment shown in FIG. 2, showing an outside handle of the device in combination with a key lock cylinder.

FIG. 7 is a section and top view of a strike assembly according to the present invention, which shows both a top and a front view of this assembly.

FIG. 8 is a section view of the latch bar housing assembly, including the housing cover and lock drive mechanism of the preferred embodiment shown in FIG. 2.

### DETAILED DESCRIPTION OF THE PREFERRED EMBODIMENT

The present invention is well suited for use with a package delivery truck or the like which has a sliding door that provides access to the vehicle for retrieving packages to be delivered. In the conventional door latch, the latch is mounted to the vehicle door. The vehicle door jamb is provided with a strike or catch that typically consists of one or more unshaped bars. This catch or strike may be provided in either the front or rear door jamb. It is also known to place a catch in both the front and rear door jambs. When the vehicle's sliding door is closed, the latch is engaged with the catch to maintain the door in that position. A handle is provided that facilitates disengagement of the latch and the catch to facilitate opening of the door.

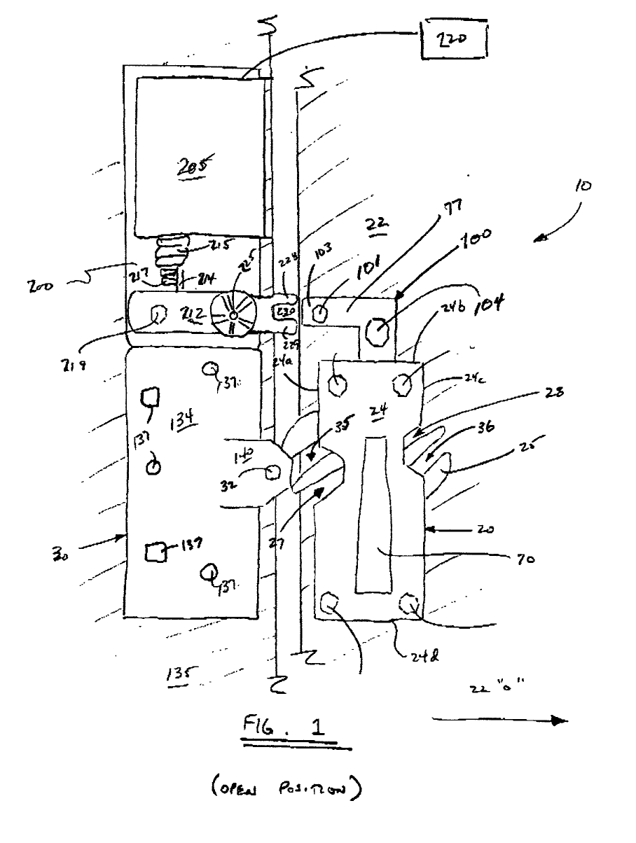

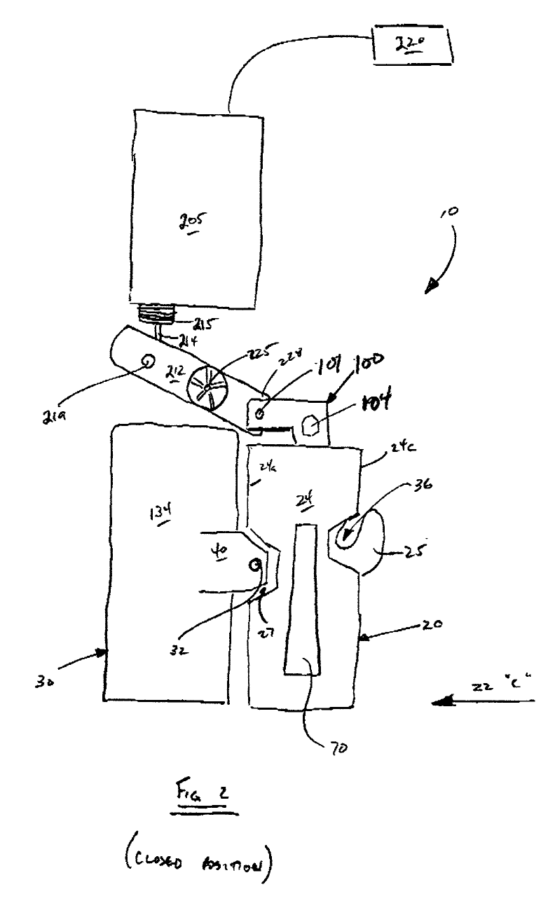

Referring now in more detail to the drawings, in which like numerals indicate like parts throughout the several views, FIG. 1 shows a preferred embodiment of the present invention generally at 10. This embodiment provides a rotary latch assembly 20 and a strike assembly 30. As shown in FIG. 1, the open position of the invention 10 is defined by a separation of the rotary latch (or latch rotor) assembly 20 separated from the strike assembly 30. As shown in FIG. 2, the closed position of the invention 10 is defined by mating engagement of the rotary latch assembly 20 and the strike assembly 30. It is to be understood that FIGS. 1 and 2 show the inside of a panel truck sliding door 22 and that the door opens in the direction of arrow “22 ‘O’” in FIG. 1 and closes in the direction of arrow “22 ‘C’” in FIG. 2.

Those of ordinary skill will appreciate that the door jambs of such vehicles are oftentimes fitted with a catch or strike that consists of one or more U-shaped bars positioned in either the front or the rear (or both) jambs relative to the vehicle door opening. While the present invention provides and includes a strike assembly 30, which is described in more detail below, it is to be understood that the present invention may be used in association with a conventional or pre-existing latch catch or strike. Conventional catch assemblies are well known in the art and need not be described further herein. When the door 22 is fully closed, the latch assembly 20 may be engaged with a conventional catch assembly. When the door 22 is in the fully opened position, the latch assembly 20 of the present invention may be fully engaged with a conventional rear catch assembly. Those of ordinary skill will appreciate that the latch assembly 20 of the present invention may be used with a conventional catch or strike. As described herein, the present invention also expressly contemplates that the latch assembly 20 and the strike assembly 30 of the present invention may be retrofit to existing vehicles and used in place of a conventional latch catch assembly. In fact, such replacement is preferred for retrofitting the present invention to existing sliding panel truck or van doors.

FIGS. 1 and 2 show a preferred strike assembly 30 and latch assembly 20 according to the present invention. Referring in detail to the latch assembly 20 shown in the drawing figures, the assembly includes a housing 24 which supports a rotary latch bar 25. The housing 24 is generally rectangular in shape, and may be made of any suitable material. A preferred material is steel or any other suitable metal, composite or sufficiently rigid material. The housing 24 defines four (4) edge surfaces 24a, 24b, 24c and 24d. The housing 24 defines two indented areas 27 and 28 in edge surfaces 24a and 24c, respectively. The ends of the latch bar 25 may be seen projecting in the indentations 27 and 28. Indentation 27 is positioned so as to receive the strike assembly 30 as described herein. Indentation 28 is positioned to receive a strike assembly (not shown) at a rearward-most position. This other strike assembly is a mirror image and substantially identical to strike assembly 30. Accordingly, this other strike assembly need not be described further herein. When the sliding door 22 is slid fully rearward to engage the other strike assembly, the sliding door is maintained in its fully opened position. When the latch assembly 20 is fully engaged with the strike assembly 30, the sliding door 22 is maintained in a fully-closed position.

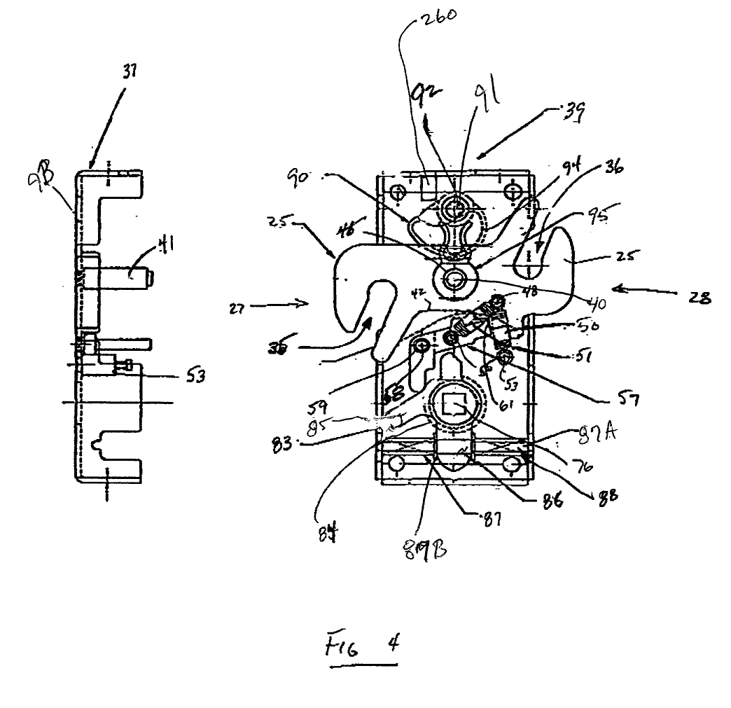

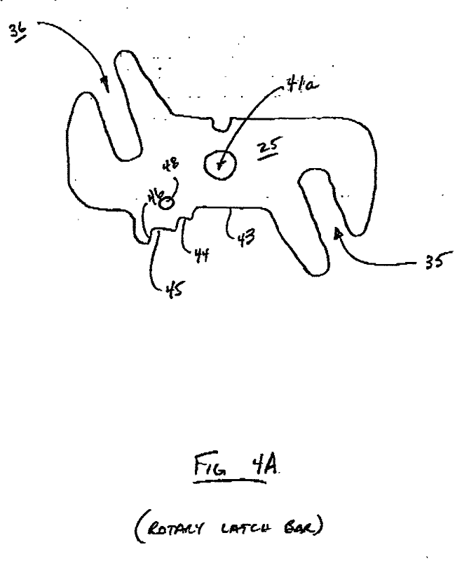

The rotary latch bar 25 is mounted for rotational movement within the latch assembly housing 24 and defines two catch slots 35 and 36. The rotary latch bar 25 is shown mounted within the housing 24 in FIG. 4. The rotary latch bar 25 is also shown, in isolation, in FIG. 4A. The catch slots 35 and 36 are sized to receive and capture a strike (described below). The slots 35 and 36 may therefore be of any suitable configuration, so long as this purpose is considered. Referring to FIG. 4A, it is seen that one possible configuration includes enlarging the area of each slot 35 and 36 at their innermost end portions so as to provide a rest area for the strike. It is to be understood that for reference purposes the indented areas 27 and 28 and the catch slots 35 and 36, as shown in FIGS. 1, 2 and 4, may be referred to as “left” or “right” for identification purposes. Such references are not meant to be limiting. In fact, it is a benefit of the present invention that it may be used interchangeably on left or right side doors 22. Thus, the orientation of the rotary latch bar 25 as shown in FIG. 4A is purposely “reversed” to demonstrate such flexibility.

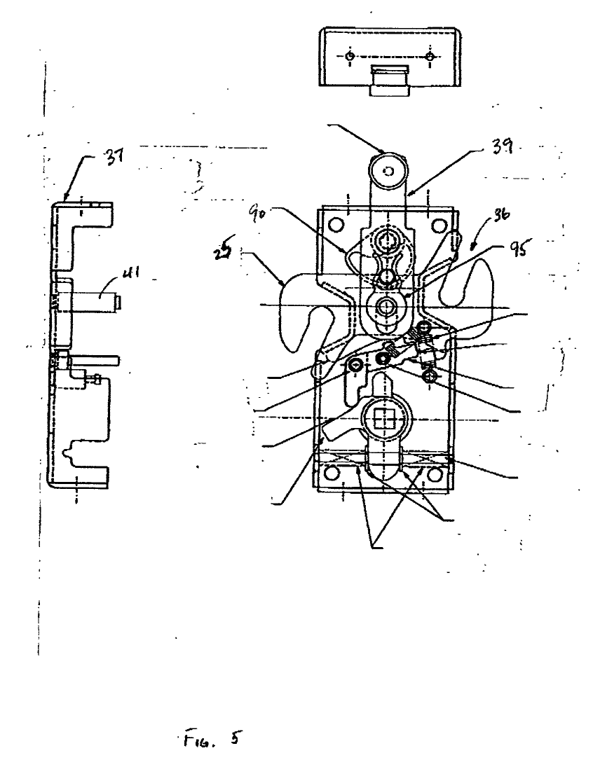

Referring in more detail to FIGS. 4, 4A and 5, the latch bar housing 24 is comprised of two sections 37 and 39. Latch bar housing member 37 is an external plate that receives and suspends a pin 41. Housing member 39 is substantially rectangular in shape and contains the lockout slide assembly and the rotary latch assembly as described herein. The preferred embodiment of housing member 39 is preferably configured for mating engagement with housing member 37. It is to be understood that the present invention is not restricted or limited by any such configuration. Housing member 39 defines an opening 40. This opening 40 is configured to receive a pin 41, described in greater detail below. The pin 41 is preferably formed integrally with housing member 37 and extends into the interior of the housing 24 to engage the opening 40 in the back wall of housing member 39. The pin 41 may be connected to housing member 37 in any suitable manner, including by a threaded opening, in conjunction with a screw (in place of the pin 41), a weld or any other conventional means. As described below, the pin 41 is stationary and supports the rotary latch bar 25.

Referring in more detail to FIG. 4A, the rotary latch bar 25 defines a center opening 41a through which pin 41 extends. Thus, pin 41 supports and facilitates rotation of the rotary latch bar 25. The rotary latch bar 25 defines a lower edge surface 43 that in turn, defines two ratchet step positions 44 and 45, and a stop surface 46. As a result, the latch bar 25 cannot rotate a complete 360°, but rather, is rotatable between different positions, the extreme positions being essentially defined by the lower surface edge 43 and the last ratchet surface 45.

The rotary latch bar 25 further includes a dual-spring post 48 that projects outwardly of the bar's surface, toward housing member 37. The dual-spring post 48 may be formed integrally with the latch bar 25 and is sized to receive one end of both a latch spring 50 and a locking arm spring 51. The latch spring 50 is secured to a latch spring post 53 that is either formed integrally with or attached to the back surface of housing member 39. See FIG. 4, for example. The locking arm spring 51 is secured to a locking arm spring post 55. The locking arm spring post 55 is either formed integrally with or for attachment to a lock arm 57. The lock arm 57 is generally L-shaped in configuration, defining a first end that is sized to engage the stop surface 46 (and the lower surface 45) of the rotary latch bar 25. The lock arm 57 may also engage rotary latch bar surfaces 43 and 44 to fix the position of the rotary latch bar 25. It is thus to be understood that the lock arm 57 is capable of rotation. This action is facilitated by a pin 58 that extends through an opening 59 in the lock arm 57. The lock arm 57 pivots about pin 58 to effect the desired action. The lock arm 57 is therefore made of any suitable material. A preferred material is steel.

The springs 50 and 51 are preferably extension springs that exert a force to their respective parts. More particularly, the latch spring 50 is secured between post 48 (on the rotary latch bar 25) and post 53 (on the housing member 39). This arrangement exerts a clockwise force against the rotary latch bar 25 so as to pull the bar into contact with a locking end surface 61 of the locking arm 57. The locking arm spring 51 (connected between post 48 on the latch bar 25 and post 55 on the locking arm 57) exerts an upward force to the right side (as shown in FIG. 4) of the locking arm 57 so as to maintain contact with the lower surface 43 of the rotary latch bar 25. In this manner, the locking end surface 61 of the locking arm 57 is forced into one of the stepped ratchet positions defined by lower surfaces 43, 44 or 45 of the rotary latch bar. It is therefore to be understood that the rotary latch bar 25 is always urged into mating engagement with the locking arm 57 by operation of the springs 50 and 51.

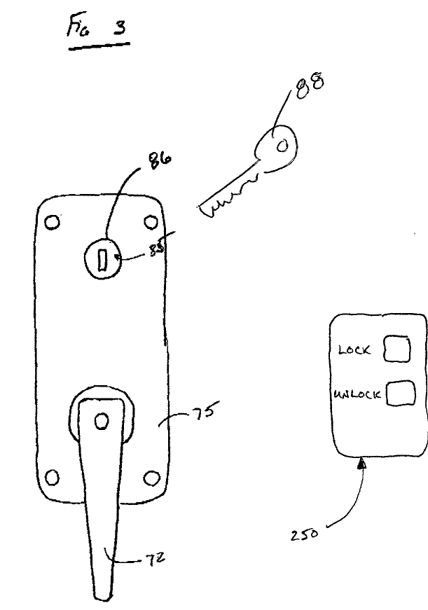

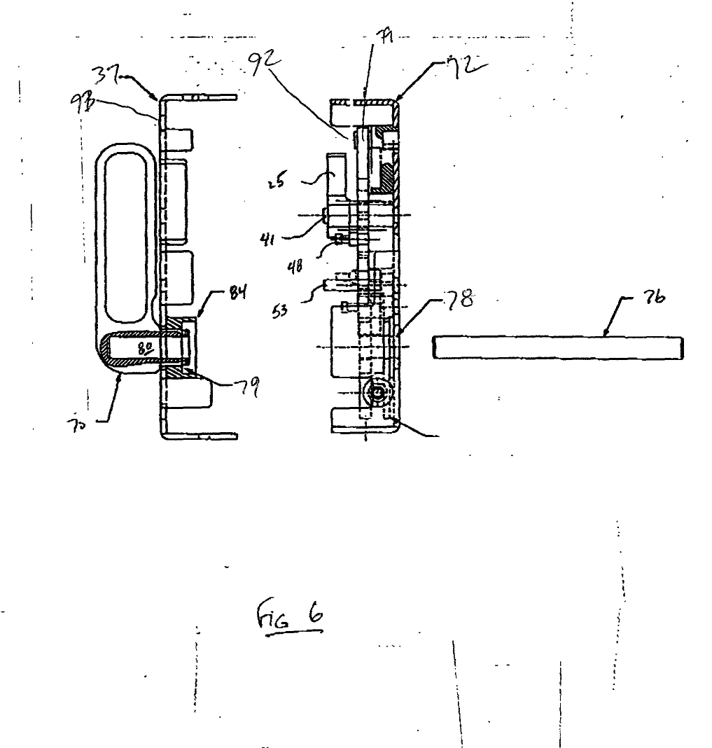

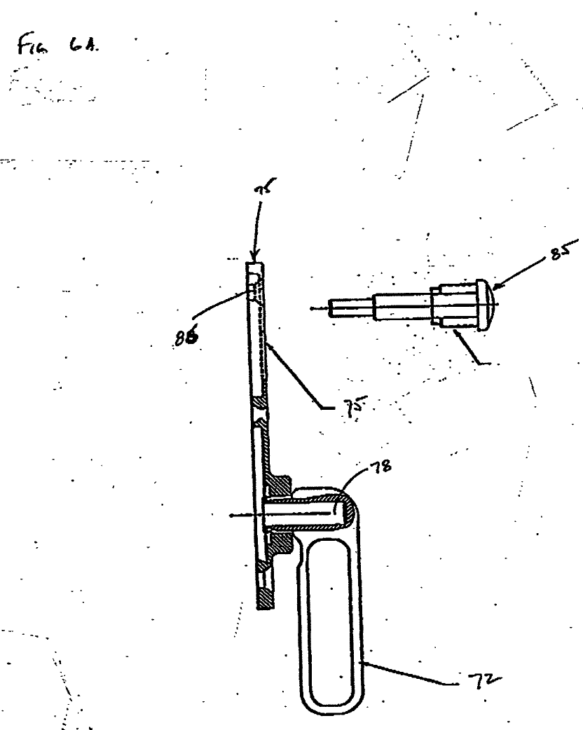

The assembly 20 further includes an inside handle 70 (see FIG. 1) and an outside handle 72 (see FIG. 6A). The outside handle 72 is shown in FIGS. 3 and 5, and is attached to an outside mounting plate 75. The outside mounting plate 75 is substantially rectangular in configuration and may be made of any suitable material, including metal, wood composite or any other rigid material. The inside handle 70 and the outside handle 72 are rigidly mounted to opposite ends of a drive shaft 76 (see FIG. 6). The drive shaft 76 extends into an opening 78 defined in the base of the outside handle 72. The drive shaft 76 extends from the opening 78 through a housing spacer plate 79 and through the interior of the latch assembly housing 24 to engage an opening 80 defined in the base of the inside handle 70.

As shown in FIG. 4, the drive shaft 76 is substantially square in cross-section. A cam 83 is rigidly mounted to the shaft 76, and cooperates with a cam bushing 84. The cam 83 includes an integral extension arm 85 that engages the lowermost extension of the locking arm 57. The cam extension 85 projects to the left of the drift shaft 76 (as shown in FIG. 4). Rotation of the drive shaft 76 in turn rotates the cam 83, causing the extension 84 to rotate in a clockwise direction. This rotation of the cam 83 causes the locking arm 57 to pivot in a clockwise direction about the pin 60 and, in turn, release the rotary latch bar 25 by separation of the end of the locking arm 61 and the lower surface ratchet steps 43, 44 or 45 of the latch bar 25. It is to be understood that either the inside handle 70 or the outside handle 72 are capable of causing such rotation of the drive shaft 76 and cam 83. A lock bar 86 is provided that cooperates with the cam 83. The bar 86, in its initial position, extends downwardly of the drive shaft 76, is bounded on one side by a centering spring 87, a spring rod 87a and a washer 87b. The cam 83 is thus held at center bias and is able to be rotated either clockwise or counterclockwise by activating handle 70, thereby releasing the locking action and permitting unlatching of the door 22.

The present invention further contemplates both keyed and keyless entry. Referring again to FIG. 3, the preferred latch bar assembly 20 includes a key lock cylinder 85 and a mating key 88. The key lock cylinder 85 fits within an opening 86 in the mounting plate 75. Generally speaking, the key lock cylinder 85 cooperates with a lockout cam 90 (see FIG. 4) to effect locking or unlocking of the panel door or the like. For example, operation of the cylinder 85 (by a key, for example) causes the lockout cam 90 to rotate about a rotor 92. The cam 90 engages a lockout slide 95 to effect locking or unlocking of the slide.

Described more particularly, the key lock cylinder 85 is shown in more detail in FIG. 6A. The lock cylinder 85 may be a conventional device defining a keyway that cooperates with a rotor and a stator to effect movement of a slide bar, bolt or the lock. Such cylinders are well known in the art and need not be further described herein. The lock cylinder 85 is inserted and retained in the opening 86 mounting plate 75 as shown in FIG. 3. Referring to FIG. 4, which shows the interior of the housing 24, the preferred locking mechanism includes the lockout cam 90 and the lockout slide 95. The lockout cam 90 is oblong in shape and defines an operating cavity 91. The cavity 91 receives a pin 92 that projects upwardly and downwardly of the lockout slide 95. The end of the lower portion of pin 92 rests within the cavity 91 and, as shown in FIG. 4, the far left end of the cavity is designed to receive the lower pin 92. FIG. 4 shows the cavity 91 receiving pin 92. FIG. 6 further shows the top portion of the pin 92, the end of which rests in a slot 93 defined in the housing member 37. The upper portion of pin 92 is captured and retained by a lockout slide spacer 96. The spacer 96 is characterized by a upper portion that preferably consists of two arms biased toward one another to capture the pin 92. The spacer 96 is further characterized by an integrally formed lower portion that is circular in configuration and defines an opening 97, the opening 97 receives the rotary latch pin 41, the lockout slide 95 defines a slot 98 through which the rotary latch pin 41 projects.

The latch assembly 20 further includes a remote control option assembly. The preferred remote consists of a generally L-shaped mounting bracket 100 that rests at the top of the latch assembly housing 24, immediately above surface 24b. (See FIG. 1.) The assembly suspends an anti-burst bolt 101 spaced vertically above. To effect this suspension, the mounting assembly defines two vertical plates, 103 and 103′ (only 103 is shown). The plates 103 and 103′ may be joined at one end but are preferably opened at the end facing the strike assembly 30. The assembly suspends the bolt 101 in a substantially horizontal position between the two plates 103 and 103′. As shown, the plates 103 and 103′ may be mounted for a slight rotation about a bolt 104, but such rotation is not necessary to effect the invention.

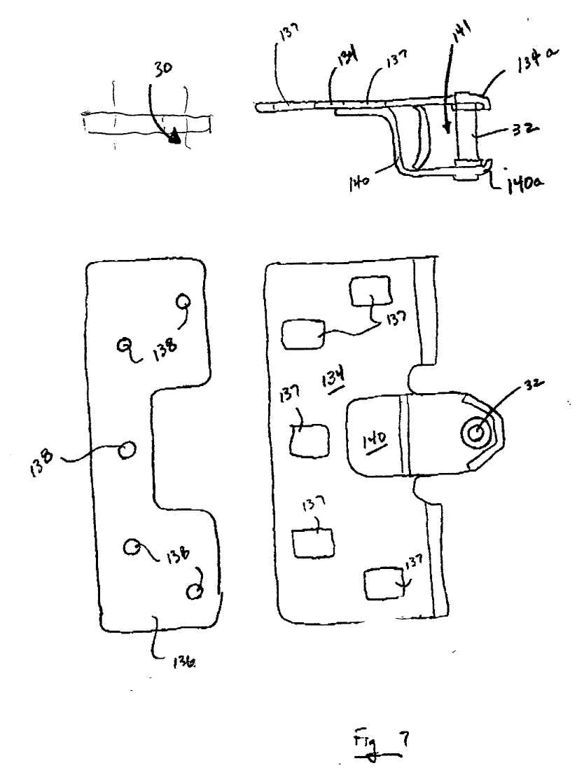

The embodiment shown in FIG. 1 further includes a strike assembly 30. The strike assembly 30 may be positioned at any location where a conventional, w-shaped catch bar is mounted. Such a conventional apparatus could typically include two catch bars mounted to angle irons which, in turn, are mounted to opposite sides of a vehicle door jam. In such an arrangement, the door 22 could be slid either forward or backward until a conventional latch would engage one or the other of the catch bars to retain the door in a fully closed or fully opened position. In the present invention, the strike assembly 30 is, for references purposes, considered to be a front strike, and is perhaps best shown in FIGS. 1, 2 and 7. Referring to FIG. 1, the strike assembly 30 includes a strike bar or catch 32. Referring to FIG. 7, it is seen that the preferred strike assembly 30 provides a mounting plate 134 that is an elongated, substantially rectangular workpiece. The mounting plate 134 is configured to be mounted upon a vehicle door jamb 135 or the like. Such mounting may be accomplished by bolts or any other suitable attachment device. The bolts may be used in connection with an adjustment plate 136. The mounting plate 134 defines openings 137. The adjustment plate similarly defines openings 138. It will be appreciated that openings 137 and openings 138 may be aligned to permit a bolt to extend therebetween and secure both the mounting plate 134 and the adjustment plate 136 to the jamb 135. Of course, in certain applications, the strike assembly 30 may be aligned with the latch assembly 20 so that the adjustment plate 136 is not necessary.

The front strike assembly 30 further includes an angle workpiece 140. The piece 140 is preferably welded to the mounting plate 134, although any suitable means of attachment (such as a fastener, glue, unitary workpiece or the like) is acceptable. As perhaps shown best in FIG. 7, this angle piece 140 creates a channel-like cavity 141 in which the strike 32 rests. Accordingly, the mounting plate 134 and the angle iron 140 support and suspend the strike 32 in the appropriate position. Further, it is to be understood that an end 134a of the mounting plate 134 and an end 140a of the angle piece 140 are best inwardly towards one another to assist in directing to rotary latch bar 25 to the strike 32. Thus, the strike 32 is positioned so as to be able to engage the slot 35 of the rotary latch bar 25, and thereby secure the position of the door 22.

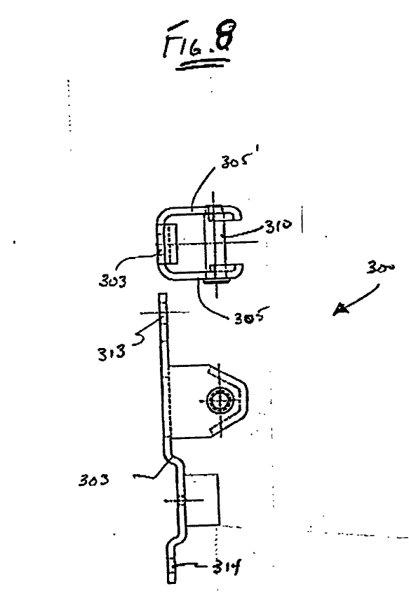

As indicated above, the present invention further contemplates use of a rear strike 300 or the like. The rear strike 300 is shown in FIG. 8. The rear strike assembly 300 is specifically configured for use in a rear strike position. The assembly 300 includes a mounting plate 303 and two forward projecting plates 305 and 305′. The plates 305 and 305′ may be formed integrally with the mounting plate 303 or for attachment therewith in any suitable manner. The plates 305 and 305′ suspend a strike 310 in position to engage the rotary latch bar 25 as described herein. Thus, the mounting plate 303 includes mounting holes 313 and 314 that can be utilized to secure the position of the strike assembly 300.

It is therefore to be understood that a latch for a sliding door of a truck or the like is provided that significantly reduces the potential of inadvertent lockout and is of rugged construction so as to significantly reduce the potential for accidental unlatching. In fact, the present invention includes several advantages over prior art designs. For example, the strike assembly 30, by means of the plates 40 and 40′ (or 305 and 305′) pilot and align the door vertically by engaging the opposing faces of the indentations 27 and 28 of the latch assembly. This aids in the latching function, especially on vehicles where bouncing of the vehicle or wear and tear may dislodge the sliding door 22. Further, the strikes 32 and 310 are adjustable in mounting position. This allows the entire assembly to compensate for door or gasket track wear and tear. These problems, while in existence and known for many years, have been un-addressed by prior art devices.

Moreover, it is to be understood that the locking slide 146 may be remotely activated. A remote control actuator device 250 is provided. (See FIG. 3). The actuator device 250 is capable of routing a signal to an encoder chip contained therein. This, in turn, sends a series of electrical pulses to a diode. The pulses form a signal in binary code that is sent to a receiver unit 260. (See FIG. 4). The receiver unit 260 includes a diode that is connected in reverse bias. The receive unit diode is connected to a decoder, that interprets or “decodes” the signal and actuates the lock, as is known in the art.

An extension plate 200 is secured to the strike assembly housing 134. The plate 200 may be made of any suitably rigid material, including wood, metal or a composite. The plate 210 supports a solenoid 205 and a movable, remote control locking bolt assembly 210. This assembly comprises a locking arm 212 connected to an elbow 214 that depends from a retractable piston 215. The elbow 214 is connected to the piston 215 by a bolt 217. The elbow 214 is connected to the arm 212 by a bolt 219. The solenoid 105 is in turn connected to an electric power source 220, preferably a source associated with the vehicle.

The arm 212 is pivotally mounted to the extension plate 200 by a pin 225 and secured by a lock washer 230. The end of the arm 212 furthest from the bolt 219 defines a jaw 227 having two fingers 128 and 129. The fingers 228 and 229 define a slot 230 therebetween that is dimensioned to receive the remote rod 101 secured between plates 103 and 103′. This operation is described in greater detail hereinbelow.

The present invention further contemplates use of a remote control device 250 to manipulate the lock system. Thus, as is known in the art, the latch assembly 20 may be provided with well-known, conventional electronics to manipulate the locking slide 146 and the cam 142 to lock or unlock the system. The most sophisticated of such systems utilizes sound waves, although a light beam or other such system may be used. For example, a sensitive microphone may be placed in the latch assembly 20 and a separate, hand-held unit fitted with a small sound emitting device such as a tuning fork. The microphone receives or “hears” the sound, and produces an electric signal that may be amplified and used to trigger a relay so as to initiate the open/lock operation of the cam 142. Such operation is now known in the art and need not be described further herein.

Further, the latch bar assembly of the present invention can be configured to accept a wide range of lock cylinders to match (or not to match) ignition locks, as security needs dictate. The present invention further provides for keyless entry, and maintains all electrical components on the stationary (jamb) side of the vehicle so as to insure reliability on a commercial vehicle that may be used frequently and roughly.

Yet other advantages include the size and manufacturing cost of the preferred embodiments, which are comparable to currently available, “lower-tech” latches. The present invention, however, offers more features and is readily adapted to many custom vehicle door configurations.

The foregoing description of the preferred embodiments of the present invention are given by way of illustration. In light thereof, those of ordinary skill in the art will appreciate that various modifications may be made departing from the spirit and scope of the invention.

We claim:

1. A latch for latching a sliding door, comprising an interior and exterior handle operatively mounted upon a sliding door; and
a latch assembly including,
a housing capable of being mounted upon said sliding door,
a biased rotary latch bar mounted within said housing, said rotary latch bar defining two opposing slots, the first of said slots opening in a generally downward direction and the second of said slots opening in a generally upward expression, said latch bar further including a first pin about which rotation of the latch bar is effected,
a rotatable locking arm that selectively engages said rotary latch bar,
a cam that, in response to manipulation of either said interior or exterior handle, engages and displaces said locking arm so as to free said rotary latch bar and thereby free said sliding door for movement.

2. The latch for latching a sliding door of claim 1 further comprising at least one spring for returning either of said interior and said exterior handles to a steady state position after said manipulation thereof to effect displacement of said locking arm.

3. The latch for latching a sliding door of claim 1 further including a drive shaft that is operatively connected between said interior handle and said exterior handle, said drive shaft being configured for receipt by an aperture defined in said cam such manipulation of either said interior handle or said exterior handle effects manipulation of said cam, locking arm and rotary latch bar.

4. The latch for latching a sliding door of claim 1 further comprising a manually operable locking device for preventing said outside handle from rotating said rotary latch bar into locking engagement with a strike.

5. The latch for latching a sliding door of claim 4 further comprising a remote control device for remotely manipulating the position of said manually operable locking device.

6. A latch for latching a sliding door at each end of its run;, comprising:
a front strike assembly;
a rear strike assembly;
a sliding door disposed between said front strike assembly and said rear strike assembly;
a latch assembly mounted upon said sliding door so as to be operable with one or the other of said front strike assembly and said rear strike assembly, said latch assembly comprising
a rotary latch bar defining opposing ends and defining a slotted opening in each said end for receipt of one of said front strike assembly or said rear strike assembly, said rotary latch bar further including a pin about which rotation is effected,
a locking arm biased against at least a surface of said rotary latch bar so as to preclude movement of said latch bar and to selectively fix the position of said latch bar,
a rotatable drive shaft connected between an inside handle and an outside handle,
a drive shaft cam mounted upon said drive shaft and rotatable with said drive shaft, said cam further including a first extension that rests between a pair of springs that constantly urge said first extension to an initial position, and a second extension that engages said locking arm,
a lock cylinder,
a second cam in operative association with said lock cylinder such that manipulation of said lock cylinder effects movements of said cam,
a spring latch device secured about said rotary latch bar pin so as to be in operative association with said lock cylinder, and
a slidable lockout slide defining a slot through which said rotary bar latch pin extends and a spring-loaded spacer,
whereby, upon accidental locking of said latch by engagement of said rotary latch bar to one of said forward strike assembly and said rear strike assembly, said lockout slide may be manipulated to unlock said latch.

7. The latch for latching a sliding door of claim 6 further comprising a remote control transmitter and receiver, said receiver enabling coded signals, and a receiver that translates said coded signals,
a solenoid that, in response to said coded signals, effects movement of an arm, and
a connecting elbow between said solenoid and said arm
whereby, upon the transmission of signals, the solenoid is activated so as to manipulate said arm and said elbow to effect movement of said lockout slide and thus remotely lock or unlock said latch assembly.
